(19) United States
(12) Patent Application Publication
(10) Pub. No.: US 2008/0211131 A1
(43) Pub. Date: Sep. 4, 2008

(54) Method and Device for the Production of Friction Linings

(75) Inventor: Wolfgang Leinweber, Wiener Neustadt (AT)

Correspondence Address: LADAS & PARRY LLP, 26 WEST 61ST STREET, NEW YORK, NY, 10023, US

(73) Assignee: LEINWEBER MASCHINEN GMBH, Weiner Neustadt (AT)

(21) Appl. No.: 10/585,621

(22) PCT Filed: Jan. 31, 2005
(86) PCT No.: PCT/AT05/00027

§ 371 Date: Apr. 25, 2008

(30) Foreign Application Priority Data
Jan. 30, 2004 (AT) A 138/2004

(51) Int. Cl. B29C 43/04; F16D 69/00

(52) U.S. Cl. 264/112; 425/517

(57) ABSTRACT

Disclosed are a method and a device for producing friction linings by pressing a pourable material (14). Said material (14) is pre-compressed against at least one support plate 9), whereupon the pre-compressed material (14) is conveyed to a press (4) and is subjected to a final compressing process in a pressing mold (11) comprising at least one hollow space (11′). The pourable material (14) is pre-compressed already in the pressing mold (11) while the pre-compressed material (14) is conveyed to the press (4) directly in the pressing mold (11) and is subjected to the final compressing process there.

The invention relates to a method for producing friction linings by pressing a pourable mass (or bulk material, respectively), wherein the mass is pre-compressed against at least one carrier plate, and subsequently the pre-compressed mass is conveyed to a press and there is subjected to a final compression in a press mold having at least one cavity, as well as to an arrangement for producing friction linings by pressing a pourable mass, including a device for pre-compression, or preforming, respectively, of the mass against at least one carrier plate, and a press with a press mold having at least one cavity for final compression of the mass, the press following the pre-compression device via a conveying unit.

Various methods and arrangements, respectively, for producing friction and brake linings are already known.

On the one hand, complex hot pressing methods (so-called true positive mold methods) are known, e.g. from JP 10202678 A, in which a pourable mass is pressed in a heated mold under controlled pressure and temperature. In such hot pressing methods, pressing of the pourable mass is effected in a comparably complicated heated press device. Such production methods and arrangements require complex tools and machines and, accordingly, are cost-intensive.

On the other hand, less complex production methods with non-heated press forms are known. However, since for a plurality of friction lining masses very high press molds of a height of approximately 250 mm would be required for introducing the pourable mass into the cavity of the press mold, and such high press molds are not economical and also involve technical disadvantages, it is known to initially pre-compress the pourable friction lining mass in an additional method step. The pre-compressed mass, i.e. the so-called pre-pressed or preformed part, is then removed from the pre-press mold and inserted in a final press mold for final compression. However, what is disadvantageous here is that the pre-pressed part can quite easily be damaged when it is removed from the pre-press mold and when it is inserted into the final press mold, and when it is transferred between the pre-press mold and the press mold, respectively, partially rendering the pre-pressed part unsuitable for use, and reducing the quality of the finished friction linings, respectively.

From EP 591 637 A, an arrangement and a method for producing friction linings is known, where at first a pre-pressed part is produced in a pre-press mold, the pre-pressed part subsequently is transferred to a carrier for transportation and from the carrier then is transferred into a heated mold for final compression. Thus, also here the pre-pressed part must be removed from the pre-press mold and introduced into a press mold for final compression.

Furthermore, from AT 398 726 B, a similar method for producing friction linings is known, in which the friction lining mass at first is pre-compressed in an intermediate mold and subsequently is transferred to a press mold for final compression.

It is an object of the present invention to provide a method and an arrangement of the initially defined type for producing friction linings, wherein damaging of the pre-pressed part is largely avoided and, thus, a high product quality is ensured with a cost-effective production of the friction lining.

To achieve this object, the invention provides for a method of the initially defined type, in which it is provided that the pourable mass is pre-compressed already in the press mold and the pre-compressed mass is conveyed directly in the press mold to the press, where it is finally compressed. By pre-compressing the pourable mass already in the press mold, in which the mass subsequently is also subjected to the final compression, transferring of the pre-compressed mass, i.e. of the pre-pressed part, from a pre-press mold, or intermediate mold, respectively, into a final press mold is not required. Since the pourable mass thus is pre- and finally compressed merely in one single press mold, there is no risk of damaging the pre-pressed part during a transfer from a pre- or intermediate mold to a final compression mold. This, moreover, has the advantage that the risk of inserting the pre-pressed part eccentrically into the cavity of the final press mold, and thereby also of producing a low-quality friction lining, is avoided. Likewise, the press form is also substantially better filled as compared to charging it with a pre-pressed part with the yet non-compressed pourable mass. Moreover, an intermediate storage of pre-fabricated pre-pressed parts is not required.

Furthermore, the carrier plates, on which the pourable mass is compressed, usually have through-holes so as to ensure as tight a connection as possible between the friction lining mass and the carrier plate in terms of a shearing force stress. Since during the pre-compression of the mass in the press mold proper, there already also occurs a pre-compression on the carrier plate, possibly present through-holes of the carrier plate are filled with the pourable friction lining mass already during the pre-compression, again resulting in an improved connection of the friction lining with the carrier plate as well as in a particularly homogeneous structure of the finished friction linings.

With regard to simple transportation of the press mold, in particular for transferring the press mold filled with the pre-compressed mass to a final compression in the press, it is advantageous if the carrier plate(s) and the press mold are put on a base plate before the pourable mass is introduced into the press mold.

If a pre-compression mold is put on the press mold before the pourable mass is introduced into the press mold, a sufficiently large cavity will result for receiving the non-compressed pourable mass before the pourable mass is pre-compressed into the cavity of the press mold.

If the pre-compression mold is lifted off the press mold after pre-compression of the pourable mass and before the press mold with the pre-compressed mass is further conveyed, the press mold including the pre-compressed mass within the cavity of the press mold can be transported in a simple manner to the press for final compression.

On the other hand, for an efficient supply and pre-compression of the pourable mass, it is also advantageous if the pourable mass is introduced into the press mold under pre-compression with the help of a screw.

To enhance the connection between the friction lining mass and the carrier plate, it is suitable if an intermediate layer, preferably of graphite, phenol resin, metal chips, glass fibers or the like, in particular in the form of a mat, is applied to the carrier plate before the pourable mass is introduced into the press mold.

Instead of applying an intermediate layer in the form of a mat on the carrier plate, it may be advantageous if the pourable intermediate layer material is applied as an intermediate layer on the carrier plate before the introduction of the pourable mass and, preferably, is pre-compressed.

With regard to a simple and cost-effective production of the friction lining it is advantageous if, before the final compression of the mass, a closing plate is put on the mass which has been pre-compressed in the press mold.

If the pre-compressed mass is subjected to several, preferably independently adjustable, press procedures for the final compression, the desired product quality of the finished friction linings can be ensured in a simple manner via an individual regulation of the individual press procedures.

If the base plate, the press mold, and the closing plate are automatically separated from each other after completion of the friction lining, a fully automated process for producing the friction linings is created.

The arrangement of the initially defined type is characterized in that the pre-compression device has a receiving means for the press mold, and in that the conveying unit is adapted for transportation of the press mold with the mass pre-compressed therein, and the press is adapted for direct final compression of the pre-compressed mass in said press mold. Here, too, the advantages already mentioned in connection with the inventive method will result, since the pre-compressed mass is not removed from a separate pre-press mold and need not be transferred into a press mold provided for final compression, but the pre-compressing device already has a receiving means for the press mold proper, so that no separate pre-press mold need be provided.

If a displaceably mounted pre-compression mold is provided as the receiving means, the pre-compression mold can be put onto the press mold in a simple manner, before the non-compressed pourable mass is introduced into a cavity formed by the pre-compression mold and the cavity of the press mold.

In order to be able to produce different friction linings using the arrangement, without requiring complex re-fitting operations therefor, it is advantageous if different pre-compression molds are provided which can be selectively chosen, e.g. by means of a rotation device.

If the height of the press mold substantially corresponds to the height of the finished friction lining, a comparatively low, cost-effective press mold is provided, and by receiving the press mold in the pre-compressing device, a sufficiently large cavity is created in a simple manner for receiving the non-compressed pourable friction lining mass before the pre-compression.

With regard to a pre-compression realized with a simple construction, it is advantageous if a plunger displaceably mounted in the pre-compression mold is provided for pre-compressing.

If a reservoir including a displaceable chute is provided for introducing the pourable mass into the pre-compression mold, the pourable mass can be introduced in a simple manner from a reservoir connected to the chute into the cavity of the press mold.

As an alternative to a pre-compression device comprising a displaceable plunger, it is also possible that an axially shiftable screw which is rotatably mounted in a housing is provided as said pre-compression device. Such a compression device is described in detail in DE 196 27 440 C2, the disclosure of which thus is included herein.

In order to pre-compress a pourable intermediate layer material on a carrier plate, and to thus improve the connection between the friction lining mass and the carrier plate, it is advantageous if an intermediate layer compression device is provided for compression of a pourable intermediate layer material upstream of the pre-compression device, viewed in conveying direction. As an alternative, the pre-compression device could also have an associated further reservoir containing the intermediate layer material in addition to the reservoir for the friction lining mass, so that with the pre-compression device both the intermediate layer material and also the friction lining mass will be compressed.

For a intermediate layer compression device that is of simple and cost-effective construction, it is advantageous if the intermediate layer compression device substantially corresponds to the construction of the pre-compression device as previously described.

In order to be able to transport the press mold between the pre-compression device and the press in a simple way, it is suitable if a base plate is provided for supporting and carrying the press form as well as, optionally, the carrier plate(s) during transportation.

For as simple and cost-effective a final compression as possible, it is advantageous if the press form has an associated closing plate which is provided to be put onto the pre-compressed mass contained in the press mold.

If the side of the closing plate facing the pre-compressed mass has a plane surface, a particularly simple final compression of the type of a so-called flash mold method will result.

Alternatively, however, it is also possible that the side of the closing plate facing the pre-compressed mass comprises at least one plunger-like projection which enters the cavity in the press mold during pressing, resulting in a final compression of the type of a so-called positive mold method.

In order to prevent an emergence of friction lining mass during compressing from the cavity of the press mold in the direction of the carrier plate, it is advantageous if the connecting region between the press mold and the carrier plate is sealed by the application of force on the press mold during final pressing.

If several, preferably independently adjustable, press stations are provided for final compression, the desired quality of the finished friction linings can be ensured in a simple manner by regulating the individual presses.

If a device for automatically separating the press mold from the base plate and from the closing plate is provided, the entire compression of the friction lining can be carried out in fully automated manner by means of the arrangement according to the invention.

In order to be able to automatically separate from each other the base plate, the press mold and the closing plate in a simple manner, it is suitable if the device includes vertically shiftable rods which have at least three portions of different diameters, starting from the portion having the smallest diameter at the freely cantilevering end of the rods, so that the rods, in their upwardly shifted position, extend through corresponding passage openings in the base plate and in the press mold, respectively, with the portion(s) of smaller diameters, whereby a selective lifting of the closing plate and of the press mold from the base plate is achieved.

If retention arms are provided for maintaining the closing plate and the press mold in their lifted positions, the separated parts can be held after lowering of the rods for lifting the closing plate and the press mold and can be supplied in sequence to a transporting device.

In the following, the invention will be explained in more detail by way of preferred exemplary embodiments illustrated in the drawings, to which, however, it shall not be restricted. In detail, in the drawings,

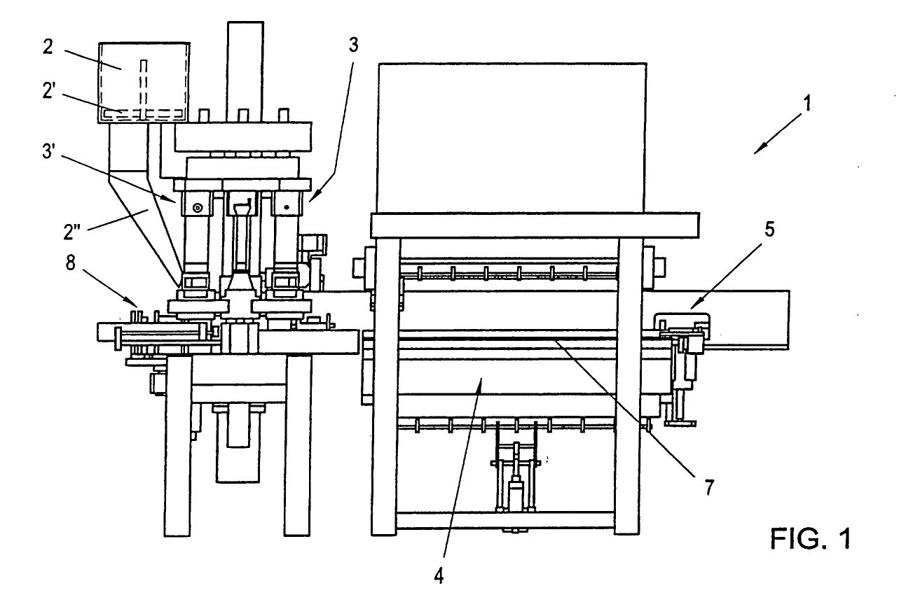

FIG. 1 shows a view of an arrangement for producing friction linings;

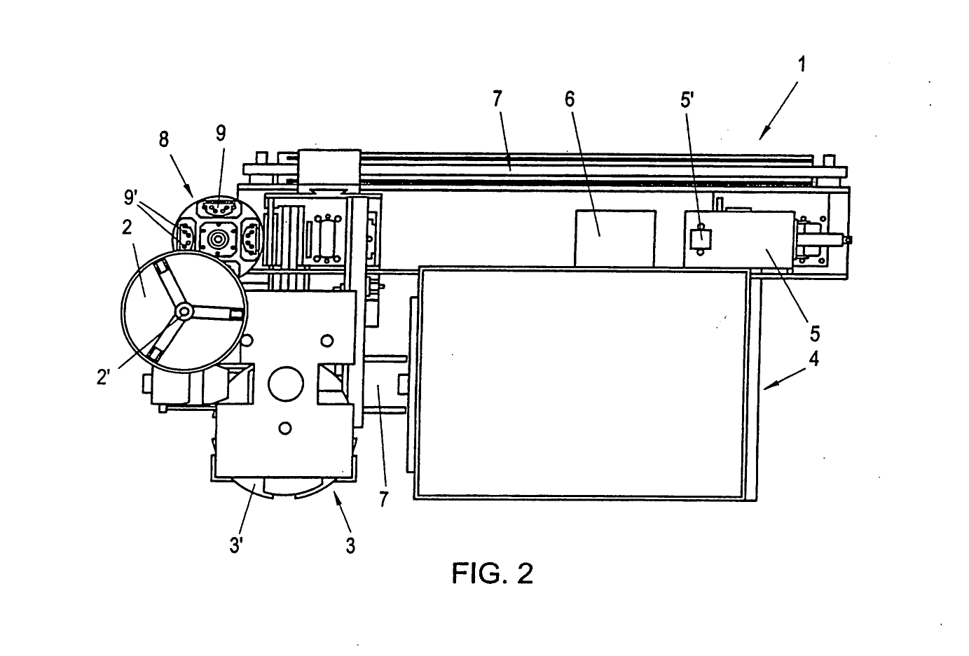

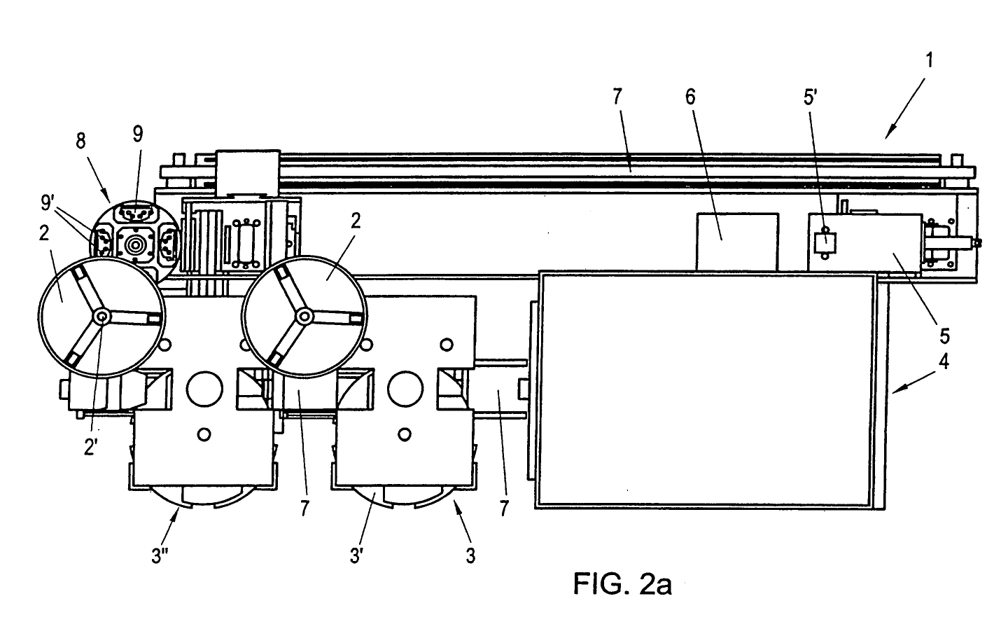

FIG. 2 shows a top view on the arrangement according to FIG. 1;

FIG. 2a shows a top view on an arrangement similar to FIG. 2, yet with an additional compressing device for compressing an intermediate layer;

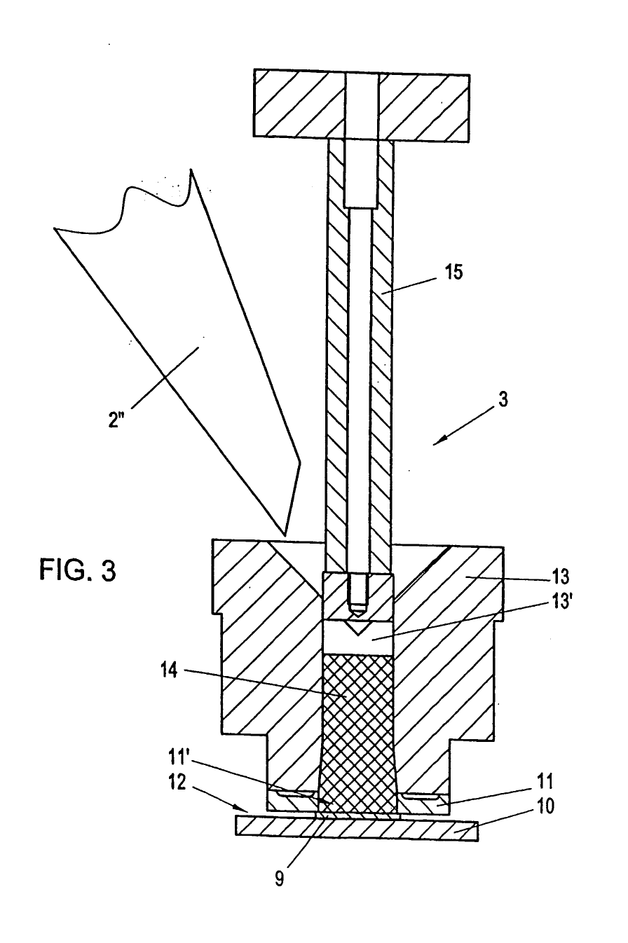

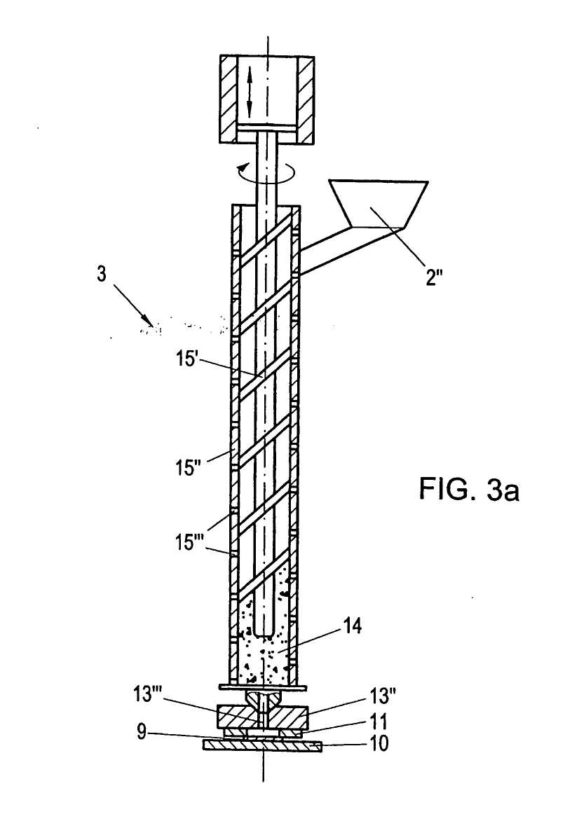

FIG. 3 schematically shows a section of a pre-compression mold put onto a press mold, which pre-compression mold is filled with yet non-compressed pourable friction lining material;

FIG. 3a schematically shows a section of an alternative pre-compression device with a screw;

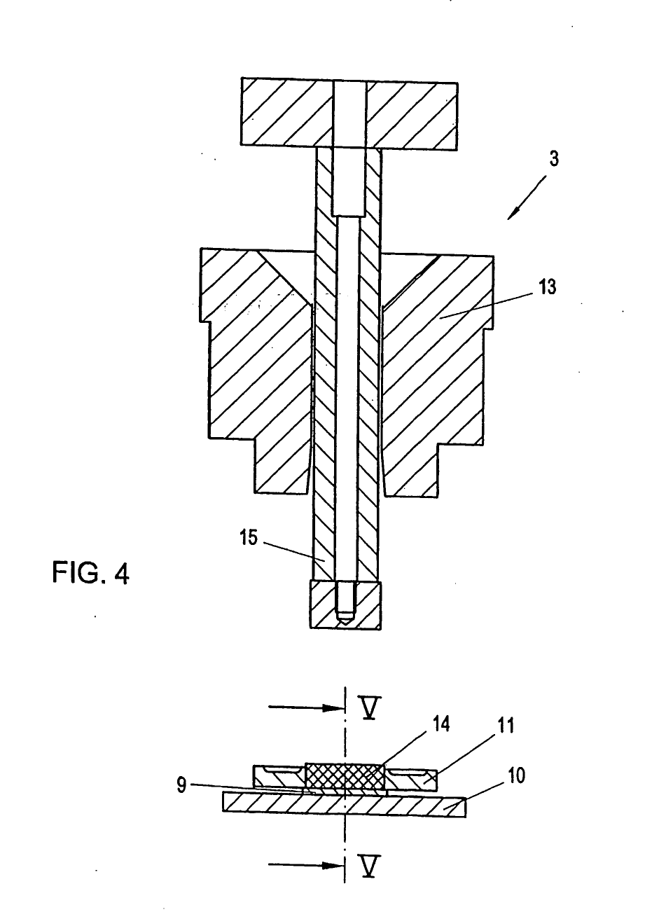

FIG. 4 schematically shows a section of the pre-compression device according to FIG. 3 after pre-compression;

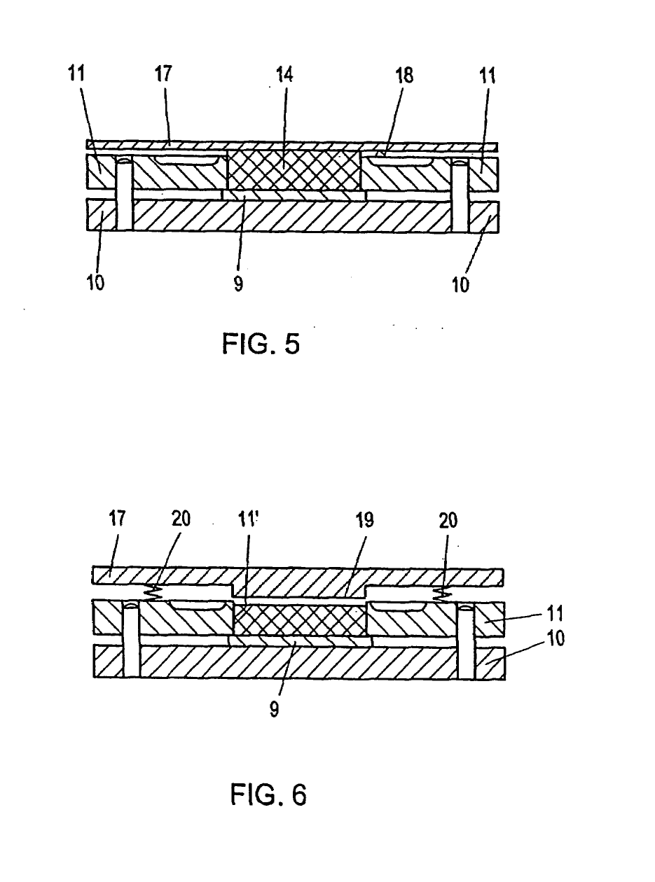

FIG. 5 schematically shows a section of a friction lining mass pre-compressed in the press mold, with a closing plate having a plane surface laid thereon;

FIG. 6 schematically shows a section similar to FIG. 5, yet with a closing plate having a plunger-type projection;

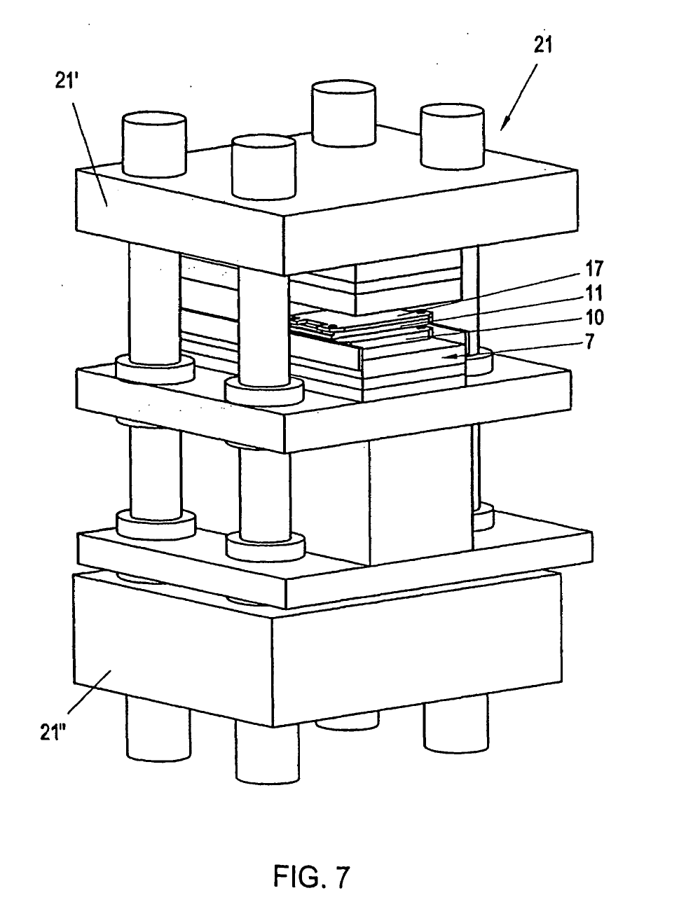

FIG. 7 schematically shows a perspective detailed view of a press station;

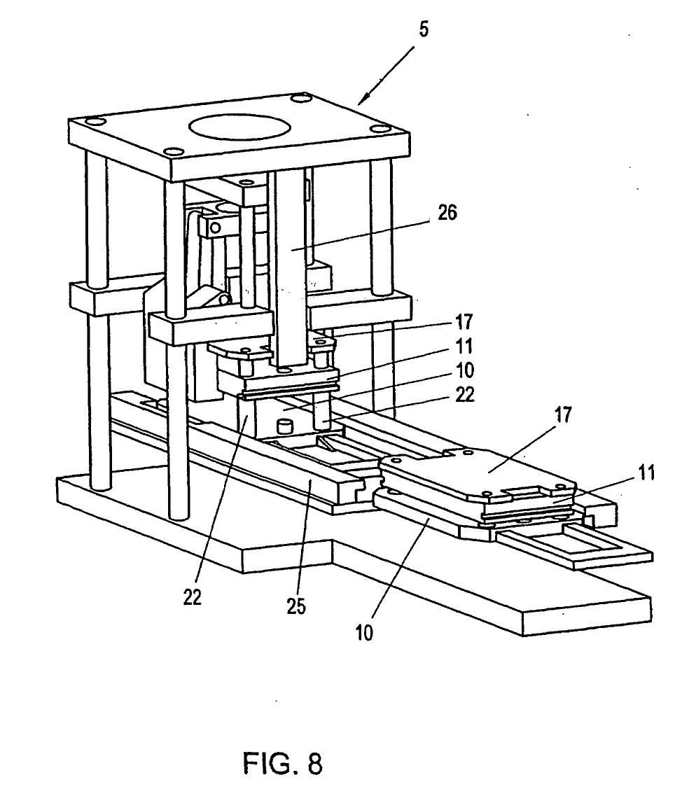

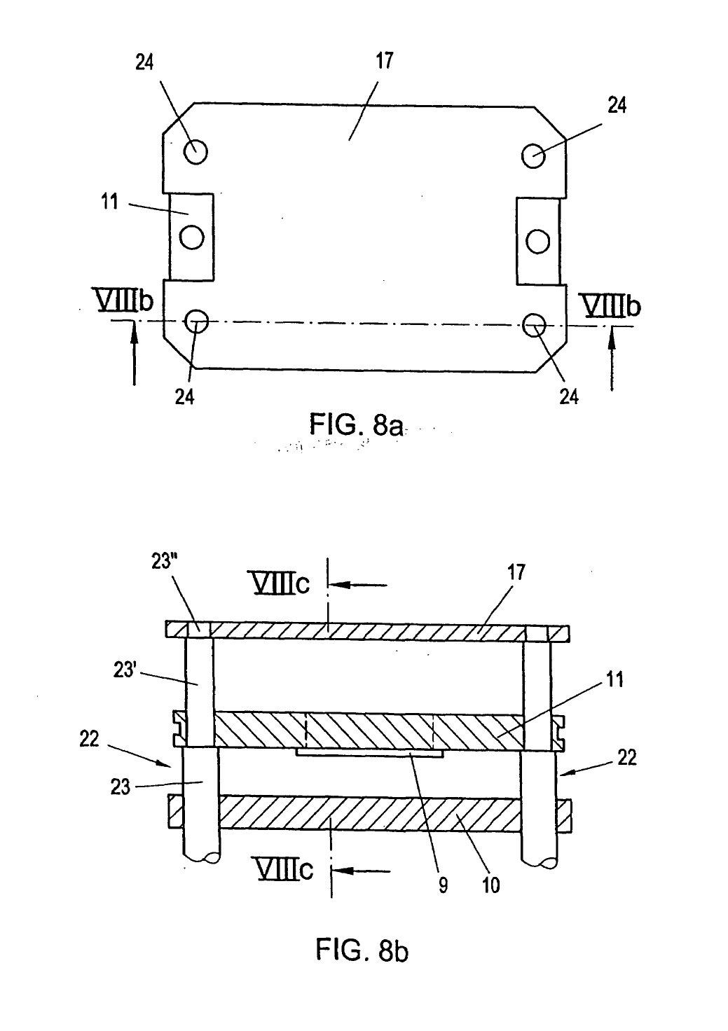

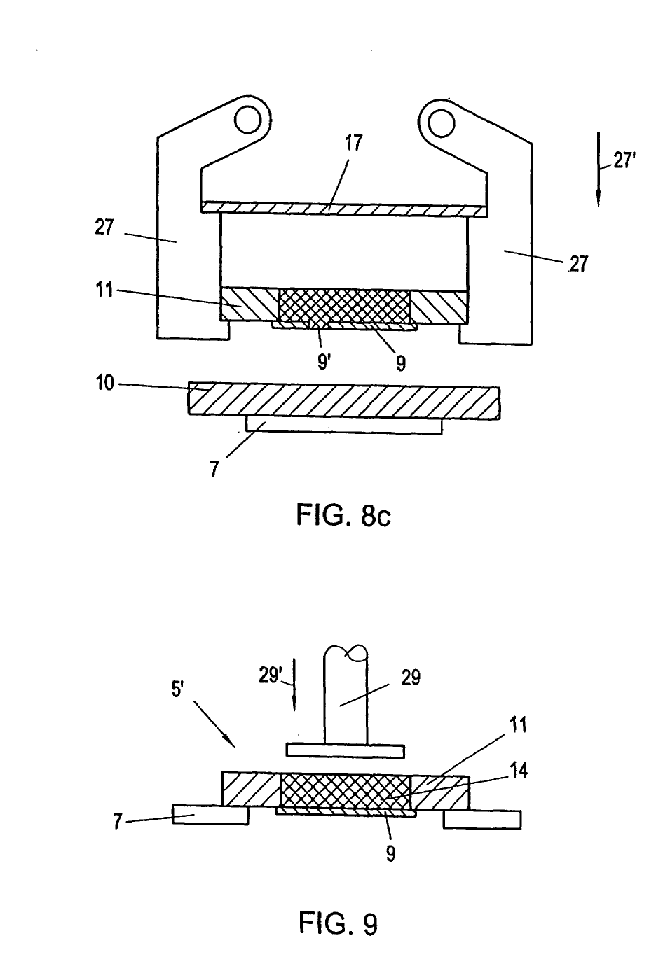

FIG. 8 shows a perspective view of a device for separating the press mold from a base plate and from the closing plate;

FIG. 8a shows a top view on a tool unit to be introduced into the arrangement according to FIG. 8;

FIG. 8b shows a section according to line VIIIb-VIIIb of FIG. 8a;

FIG. 8c shows a section according to line VIIIc-VIIIc of FIG. 8b; and

FIG. 9 schematically shows a section of an arrangement for ejecting the finished friction lining.

In FIGS. 1 and 2, an arrangement 1 for the fully automated production of a friction lining, in particular a brake lining, is schematically shown, which arrangement substantially is assembled of a reservoir 2 for the pourable friction lining mass, a pre-compression device 3, a press 4 including several press stations, a tool separating device 5 as well as a friction lining-ejection device 5′, a cleaning and a spraying unit 6 as well as a conveying device 7 and a carrier plate magazine 8.

As is particularly visible from FIG. 3, at first a carrier plate 9 is taken from the carrier plate magazine 8 and put onto a base plate 10. Subsequently, a press mold 11 is laid onto the carrier plate 9, and this tool unit 12 is transported into the pre-compression unit 3.

In the pre-compression unit 3, a vertically displaceably mounted pre-compression mold 13 is provided which, after unit 12 has been positioned, is put onto the press mold 11. Thereby, from a cavity 11′ in the press mold 11 and from a cavity 13′ in the pre-compression mold 13, a mutual cavity is formed for receiving the non-compressed pourable friction lining mass 14 stored in a reservoir 2. Via a stirrer 2′ as well as a conveying and dosing unit, a pre-determined amount of friction lining mass 14 is introduced into the receiving means formed by cavities 11′ and 13′ by means of a chute 2″ whose lower end is pivoted to the upper opening of the pre-compression mold 13.

In order to make it possible to provide corresponding pre-compression molds 13 for different carrier plates 9 without any time-consuming retrofitting, e.g. four pre-compression molds 13 arranged offset by 90° relative to each other are mounted on a rotation device 3′ of the pre-compression unit 3. Accordingly, depending on the position of the rotation device 3′, a different pre-compression mold 13 can be inserted.

In the pre-compression unit 3, furthermore, a plunger 15 is provided which is displaceable within the pre-compression mold 13 so that—as is particularly visible in FIGS. 3 and 4—the friction lining mass 14 is pre-compressed on the carrier plate 9. During this pre-compression, also a pre-compression of the friction lining mass 14 occurs in the through holes 9′ (cf. FIG. 2) of the carrier plate 9.

Alternatively to the FIG. 3-illustrated pre-compression device having a displaceable plunger 15, also a pre-compression device 3 visible in FIG. 3a and having a screw 15′ rotatably mounted in a housing 15″ and displaceable along its axis may be provided. In this case, the friction lining mass 14 will be introduced into the cylindrical housing 15″ via a hopper 2″, the housing 15″ being heated by a heating means 15′″. This causes melting of the binder contained in the friction lining mass 14, so that the viscosity of the friction lining mass 14 is lowered and the plastified mass is conveyed by the screw 15′ to the front region of the housing 15″. During this dosing procedure in the direction of a top plate, the screw 15′ is pushed back into an upper end position. Subsequently, by pushing the screw 15′ forwards, the plastified friction lining mass is pressed into the press mold 11 through an injection channel 13′″ provided in a top plate 13″. Here, the advancement of the screw 15′ preferably is generated by means of a hydraulic cylinder.

As can be seen from FIG. 4, after pre-compression of the friction lining mass 14, the pre-compression mold 13 is shifted upwards, before a closing plate 17 (cf. FIGS. 5 and 6) is automatically laid onto the pre-compressed mass 14.

Other than in the arrangement shown in FIG. 2, in the arrangement according to FIG. 2a, an intermediate layer compression device 3′ is additionally provided. This intermediate layer compression device 3′ comprises a reservoir 2 in which a pourable intermediate layer material consisting, e.g., of graphite, phenol resins, metal chips, glass fibers or the like, is received, which is provided for improving the connection between the friction lining mass 14 and the carrier plate 9. For compressing the intermediate layer material on the carrier plate 9, the intermediate layer compression device 3″ may essentially be constructed like the pre-compression device 3 previously described by way of FIGS. 3 and 3a, respectively, reference being made to what has been said there in order to avoid repetitions.

As can be seen from FIG. 5, the closing plate 17 may have a plane surface 18 on its side facing the friction lining mass 14, in order to achieve pressing in the manner of a flash mold process in the subsequent hot pressing process in press 4.

However, on the other hand, as shown in FIG. 6, also a closing plate 17 may be laid on, which closing plate has a plunger 19 entering in the cavity 11′ of the press mold 11 so that pressing in the manner of a positive mold method is achieved in press 4 in the subsequent hot pressing method. Particularly in case of a closing plate 17 having a plunger 19, the transition between the cavity 11′ of the press press mold 11 and the carrier plate 9 can be sealed by the action of a force created by springs 20 connected to the closing plate 17.

After the closing plate 17 has been laid on the pre-compressed mass 14, the entire unit arranged on the base plate 10 is transported into the press 4 for hot pressing for the purpose of a final compression, the press 4 having several press stations 21 (cf. FIG. 7), each one having a press upper part 21′ and a press lower part 21″. By the indexed further transport between the press stations 21 and the opening and closing of the press stations 21 associated therewith, a sufficient venting of the friction lining mass 14 is ensured between the individual pressing procedures.

After having left the press 4, the tool unit 12—consisting of the base plate 10, the carrier plate 9 with the completely compressed friction lining mass 14, the press mold 11 and including the closing plate 17—is transported into the tool separating device 5 (cf. in particular FIGS. 8, 8a-8c).

As is particularly visible from FIGS. 8 and 8b, the tool separating device 5 includes four vertically displaceably mounted rods 22 which each comprise three sections 23, 23′, 23″ of different diameters. Corresponding through-holes 24 of different diameters (cf. FIG. 8a) are provided in the closing plate 17 as well as in the press mold 11 and in the base plate 10, so that the rods 22 shifted from bottom to top will extend through the cross-sectionally largest through-holes 24 of the base plate 10, just as the cross-sectionally smallest portion 23″ of the rods 22 will do through the through-holes 24 in the press mold 11, so that the end portion 23″ of the rods 22 comes to lie in the through-holes 24 of the closing plate 17 and so that the closing plate 17 is lifted by means of the step-like shoulder for the cross-sectional enlargement to the portion 23′, just as is the press mold 11 with the help of a second step-like shoulder for the cross-sectional enlargement to the portion 23 of the rods 22.

In order to avoid an undesired lifting of the base plate 10, the base plate 10 is retained in the tool separating device 5 by two lateral hold-down webs 25. To separate the closing plate 17 from the press mold 11, hold-down means 26 are provided.

As is particularly visible from FIGS. 8 and 8c, the press mold 11 lifted off the base plate 10 as well as the closing plate are maintained in their lifted position after pivoting of retention arms 27 actuated e.g., by means of air cylinders, even after the rods 22 have been shifted downwardly again (cf. FIG. 8c). Subsequently, the base plate 10 is the first one to be transported back by a conveying device 7, e.g. by means of a sled.

Then the retaining arms 27 are lowered in the direction of arrow 27′ so that the press mold 11 is lowered onto the conveying device 7 and is moved on with the conveying device 7 to an ejection device 5′.

In the ejection device 5′, the final-compressed friction lining mass 14 including the carrier plate 9 is ejected from the cavity 11′ of the press mold 11 by an ejector 29 which is shifted in the direction of arrow 29′, and subsequently is also transported in the direction of the returning device.

Finally, also the closing plate 17 is lowered onto the conveying device 7 and moved to the returning device, so that the base plate 10 as well as the press mold 11 and the closing plate 17 are cleaned and sprayed in a cleaning and spraying unit 6. With the aid of the conveying device 7, the base plate 10, the press mold 11 as well as the closing plate 17 thus are conveyed in a circle so that they can be provided for another run through the production process when a finished friction lining has been produced.

Of course, the press mold 11 may have any desired number of cavities 11′, and also different devices can be provided for the pre- and final compressions. What is essential is merely that the friction lining mass is pre-compressed already in the press mold 11 proper, before the press mold 11 is transported to the hot press 4 for the final compression.

1. A method for producing friction linings by pressing a pourable mass (14), wherein the mass (14) is pre-compressed and subsequently the pre-compressed mass (14) is conveyed to a press (4) and there is subjected to a final compression in a press mold (11) having at least one cavity (11′), characterized in that the pour-able mass (14) is pre-compressed already in the press mold (11) against at least one carrier plate (9), and the pre-compressed mass (14) that has been pre-compressed against the carrier plate (9) is conveyed directly in the press mold (11) to the press (4) where it is finally compressed.

2. A method according to claim 1, characterized in that the carrier plate(s) (9) and the press mold (11) are put on a base plate (10) before the pourable mass (14) is introduced into the press mold (11).

3. A method according to claim 1, characterized in that a pre-compression mold (13) is put on the press mold (11) before the pourable mass (14) is introduced into the press mold (11).

4. A method according to claim 3, characterized in that the pre-compression mold (13) is lifted off the press mold (11) after pre-compression of the pourable mass (14) and before the press mold (11) with the pre-compressed mass (14) is further conveyed.

5. A method according to claim 1, characterized in that the pourable mass (14) is introduced into the press mold (11) under pre-compression with the help of a screw (15′).

6. A method according to claim 1, characterized in that an intermediate layer, preferably of graphite, phenol resin, metal chips, glass fibers or the like, in particular in the form of a mat, is applied to the carrier plate (9) before the pourable mass (14) is introduced into the press mold (11).

7. A method according to claim 6, characterized in that pourable intermediate layer material is applied as an intermediate layer on the carrier plate before the introduction of the pourable mass (14) and, preferably, is pre-compressed.

8. A method according to claim 1, characterized in that, before the final compression of the mass (14), a closing plate (17) is put on the mass (14) that has been pre-compressed in the press mold.

9. A method according to claim 1, characterized in that the pre-compressed mass (14) is subjected to several, preferably independently adjust-able, press procedures for the final compression.

10. A method according to claim 8, characterized in that the base plate (10), the press mold (11), and the closing plate (17) are automatically separated from each other after completion of the friction lining.

11. An arrangement for producing friction linings by pressing a pourable mass (14), including a device (3) for pre-compression of the mass (14) and a press (4) with a press mold (11) having at least one cavity (11′) for final compression of the mass (14), the press (4) following the pre-compression device (3) via a conveying unit (7), characterized in that the pre-compression device (3) has a receiving means for the press mold (11), and in that the conveying unit (7) is adapted for transportation of the press mold (11) with the mass (14) pre-compressed against at least one carrier plate (9) therein, and the press (4) is adapted for direct final compression of the pre-compressed mass (14) in the press mold (11) against the carrier plate (9).

12. An arrangement according to claim 11, characterized in that a displaceably mounted pre-compression mold (13) is provided as the receiving means.

13. An arrangement according to claim 12, characterized in that different pre-compression molds (13) are provided which can be selectively chosen e.g. by means of a rotation device (3′).

14. An arrangement according to claim 11, characterized in that the height of the press mold (11) substantially corresponds to the height of the finished friction lining.

15. An arrangement according to claim 12, characterized in that a plunger (15) compressing the pourable mass (14) in the pre-compression mold (13) is provided for pre-compressing.

16. An arrangement according to claim 12, characterized in that a reservoir (2) including a displaceable chute (2″) is provided for introducing the pourable mass (14) into the pre-compression mold (13).

17. An arrangement according to claim 11, characterized in that an axially shiftable screw which is rotatably mounted in a housing is provided as said pre-compression device (3).

18. An arrangement according to claim 11, characterized in that an intermediate layer compression device (3″) is provided for compression of a pourable intermediate layer material upstream of the pre-compression device (3), viewed in conveying direction.

19. (canceled)

20. An arrangement according to claim 11, characterized in that a base plate (10) is provided for supporting and carrying the press form (11) as well as, optionally, the carrier plate(s) (9) during transportation.

21. An arrangement according to claim 11, characterized in that the press form (11) has an associated closing plate (17) which is provided to be put onto the pre-compressed mass (14) contained in the press mold (11).

22. An arrangement according to claim 21, characterized in that the side of the closing plate (17) facing the pre-compressed mass (14) has a plane surface (18).

23. An arrangement according to claim 21, characterized in that the side of the closing plate (17) facing the pre-compressed mass (14) comprises at least one plunger-like projection which enters the cavity (11′) in the press mold (11) during pressing.

24. An arrangement according to claim 22, characterized in that the connecting region between the press mold (11) and the carrier plate (9) is sealed by the application of force on the press mold (11) during final pressing.

25. An arrangement according to claim 12, characterized in that several, preferably independently adjustable, press stations (21) are provided for final compression.

26. An arrangement according to claim 12, characterized in that a device (5) for automatically separating the press mold (11) from the base plate (10) and from the closing plate (17) is provided.

27. An arrangement according to claim 26, character-ized in that the device (5) includes vertically shiftable rods (22) which have at least three portions (23, 23′, 23″) of different diameters, starting from the portion (23″) having the smallest diameter at the freely cantilevering end of the rods (22), so that the rods (22), in their upwardly shifted position, extend through corresponding passage openings in the base plate (10) and in the press mold (11), respectively, with the portion(s) (23′, 23″) of smaller diameters, whereby a selective lifting of the closing plate (17) and of the press mold (11) from the base plate (10) is achieved.

28. An arrangement according to claim 27, characterized in that retention arms (27) are provided for maintaining the closing plate (17) and the press mold (11) in their lifted positions.
